(19) United States
(12) Patent Application Publication
(10) Pub. No.: US 2023/0410254 A1
(43) Pub. Date: Dec. 21, 2023

(54) TASK-AWARE POINT CLOUD DOWN-SAMPLING

(71) Applicant: InterDigital Patent Holdings, Inc., Wilmington, DE (US)

(72) Inventors: Haiyan Wang, New York, NY (US); Jiahao Pang, Plainsboro, NJ (US); Muhammad Asad Lodhi, Highland Park, NJ (US); Dong Tian, Boxborough, MA (US)

(21) Appl. No.: 18/036,605

(22) PCT Filed: Nov. 12, 2021
(86) PCT No.: PCT/US2021/059074

§ 371 Date: May 11, 2023

Related U.S. Application Data
(60) Provisional application No. 63/119,129, filed on Nov. 30, 2020.

(51) Int. Cl. G06T 3/40; G06T 7/73; H04N 19/42; H04N 19/50; H04N 19/172; H04N 19/132; H04N 19/13; H04N 19/136

(52) U.S. Cl. CPC G06T 3/4046; G06T 7/73; H04N 19/42; H04N 19/50; H04N 19/172; H04N 19/132; H04N 19/13; H04N 19/136; G06T 2207/20084; G06T 2207/10028; G06T 2207/10016

(57) ABSTRACT

A method includes generating, using a neural network, a point-level feature vector for each point of a point cloud and a set-level feature vector for the point cloud. A representative position is generated based on the point-level feature vectors and on the set-level feature vector. The representative position and the set-level feature vector is output as a set descriptor.

### 1. TECHNICAL FIELD

The present principles generally relate to the domain of point cloud processing. The present document is also understood in the context of the analysis, the interpolation, the representation and the understanding of point cloud signals.

### 2. BACKGROUND

The present section is intended to introduce the reader to various aspects of art, which may be related to various aspects of the present principles that are described and/or claimed below. This discussion is believed to be helpful in providing the reader with background information to facilitate a better understanding of the various aspects of the present principles. Accordingly, it should be understood that these statements are to be read in this light, and not as admissions of prior art.

Point cloud is a data format used across several business domains including autonomous driving, robotics, AR/VR, civil engineering, computer graphics, and the animation/movie industry. 3D LIDAR sensors have been deployed in self-driving cars, and affordable LIDAR sensors are included with, for example, Apple iPad Pro 2020 and Intel Real Sense LIDAR camera L515. With advances in sensing technologies, three-dimensional (3D) point cloud data has become more practical and is expected to be a valuable enabler in the applications mentioned.

At the same time, point cloud data may consume a large portion of network traffic, e.g., among connected cars over a 5G network, and immersive communications (virtual or augmented reality (VR/AR)). Point cloud understanding and communication would essentially lead to efficient representation formats. In particular, raw point cloud data need to be properly organized and processed for the purposes of world modeling and sensing.

Furthermore, point clouds may represent a sequential scan of the same scene, which contains multiple moving objects. These are called dynamic point clouds as compared to static point clouds captured from a static scene or static objects. Dynamic point clouds are typically organized into frames, with different frames being captured at different time.

3D point cloud data are essentially discrete samples of the surfaces of objects or scenes. To fully represent the real world with point samples, in practice, a large number of points is required. For instance, a typical VR immersive scene contains millions of points, while point cloud maps typically contain hundreds of millions of points. Therefore, the processing of such large-scale point clouds is computationally expensive, especially for consumer devices that have limited computational power, e.g., smartphones, tablets, and automotive navigation systems.

Point cloud data are key for various applications, such as autonomous driving, VR/AR, topography and cartography, etc. However, consuming a large point cloud directly incurs significant computational costs. Consequently, it is important to adaptively down-sample the input point cloud to facilitate subsequent tasks. Such a down-sampling process is useful for scene-flow estimation, point cloud compression, and other general computer vision tasks.

### 3. SUMMARY

The following presents a simplified summary of the present principles to provide a basic understanding of some aspects of the present principles. This summary is not an extensive overview of the present principles. It is not intended to identify key or critical elements of the present principles. The following summary merely presents some aspects of the present principles in a simplified form as a prelude to the more detailed description provided below.

The present principles relate to a method that generates, using a neural network, a point-level feature vector for each point of a point cloud and a set-level feature vector for the point cloud. A representative position based on the point-level feature vectors and on the set-level feature vector is generated. The representative position and the set-level feature vector are output as a set descriptor.

In another embodiment, a method for retrieving a point cloud from a data stream obtains, from the data stream, a down-sampled point cloud and a residual point cloud. The down-sampled point cloud is fed to a predictor construction module to obtain a predicted point cloud. The point cloud is retrieved by adding the predicted point cloud to the residual point cloud.

The present principles also relate to device comprising at least one processor associated with at least one memory configured to implement embodiments corresponding to the methods above.

### 4. BRIEF DESCRIPTION OF DRAWINGS

The present disclosure will be better understood, and other specific features and advantages will emerge upon reading the following description, the description making reference to the annexed drawings wherein:

FIG. 1 illustrates a method 10 of down-sampling an input point cloud X with n points for subsequent machine tasks, according to a non-limiting embodiment of the present principles;

FIG. 2 diagrammatically illustrates the SD function, according to a non-limiting embodiment of the present principles;

FIG. 3 illustrates an example, where a point A is chosen as the representative point because it has the largest weight;

FIG. 4 illustrates a fifth embodiment of down-sampling an input point cloud according to the present principles;

FIG. 5 diagrammatically illustrates how to integrate the task-aware point cloud down-sampling method of the present principles with a sub-sequent machine task;

FIG. 6 illustrates a seventh embodiment of an integrated task-aware point cloud down-sampling method;

FIG. 7 illustrates a method of point cloud compression using an embodiment of a task-aware point cloud down-sampling method according to the present principles;

FIG. 8 illustrates a decoder embodiment of the present principles; and

FIG. 9 shows an example architecture of a device 30 which may be configured to implement a method described in relation to FIG. 1.

### 5. DETAILED DESCRIPTION OF EMBODIMENTS

The present principles will be described more fully hereinafter with reference to the accompanying figures, in which examples of the present principles are shown. The present principles may, however, be embodied in many alternate forms and should not be construed as limited to the examples set forth herein. Accordingly, while the present principles are susceptible to various modifications and alternative forms, specific examples thereof are shown by way of examples in the drawings and will herein be described in detail. It should be understood, however, that there is no intent to limit the present principles to the particular forms disclosed, but on the contrary, the disclosure is to cover all modifications, equivalents, and alternatives falling within the spirit and scope of the present principles as defined by the claims.

The terminology used herein is for the purpose of describing particular examples only and is not intended to be limiting of the present principles. As used herein, the singular forms “a”, “an” and “the” are intended to include the plural forms as well, unless the context clearly indicates otherwise. It will be further understood that the terms “comprises”, “comprising,” “includes” and/or “including” when used in this specification, specify the presence of stated features, integers, steps, operations, elements, and/or components but do not preclude the presence or addition of one or more other features, integers, steps, operations, elements, components, and/or groups thereof. Moreover, when an element is referred to as being “responsive” or “connected” to another element, it can be directly responsive or connected to the other element, or intervening elements may be present. In contrast, when an element is referred to as being “directly responsive” or “directly connected” to other element, there are no intervening elements present. As used herein the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the present principles.

Although some of the diagrams include arrows on communication paths to show a primary direction of communication, it is to be understood that communication may occur in the opposite direction to the depicted arrows.

Some examples are described with regard to block diagrams and operational flowcharts in which each block represents a circuit element, module, or portion of code which comprises one or more executable instructions for implementing the specified logical function(s). It should also be noted that in other implementations, the function(s) noted in the blocks may occur out of the order noted. For example, two blocks shown in succession may, in fact, be executed substantially concurrently or the blocks may sometimes be executed in the reverse order, depending on the functionality involved.

Reference herein to “in accordance with an example” or “in an example” means that a particular feature, structure, or characteristic described in connection with the example can be included in at least one implementation of the present principles. The appearances of the phrase in accordance with an example” or “in an example” in various places in the specification are not necessarily all referring to the same example, nor are separate or alternative examples necessarily mutually exclusive of other examples.

Reference numerals appearing in the claims are by way of illustration only and shall have no limiting effect on the scope of the claims. While not explicitly described, the present examples and variants may be employed in any combination or sub-combination.

The automotive industry and autonomous cars are domains in which point clouds may be used. Autonomous cars should be able to “probe” their environment to make good driving decisions based on the reality of their immediate surroundings. Typical, sensors like LIDARs produce (dynamic) point clouds that are used by a decision engine. These point clouds are not intended to be viewed by human eyes and they are typically sparse, not necessarily colored, and dynamic with a high frequency of capture. They may have other attributes like the reflectance ratio provided by the LIDAR as this attribute is indicative of the material of the sensed object and may help in making a decision.

Virtual Reality (VR) and immersive worlds have become widely discussed, foreseen by many as the future of 2D flat video. The basic idea is to immerse the viewer in an environment all around him as opposed to standard TV where he only views the virtual world in front of him. There are several gradations in the immersivity depending on the freedom of the viewer in the environment. Point cloud is a good format candidate to distribute VR worlds. They may be static or dynamic and are typically of average size, for example, no more than millions of points at a time.

Point clouds may be also used for various purposes such as cultural heritage/buildings in which objects like statues or buildings are scanned in 3D in order to share the spatial configuration of the object without sending or physically visiting it. This also provides a way to preserve the information and data about the object in case it may be destroyed; for instance, a temple by an earthquake. Such point clouds are typically static, colored, and relatively large.

Another use case is in topography and cartography in which using 3D representations and maps are not limited to a plane and may include relief features. Google Maps is one example of 3D maps that uses meshes instead of point clouds. Nevertheless, point clouds may be a suitable data format for 3D maps and such point clouds are typically static, colored, and relatively large.

World modeling & sensing via point clouds could be a technology to allow machines to gain knowledge about the 3D world around them, helpful for the applications discussed above.

3D point cloud data are essentially discrete samples of the surfaces of objects or scenes. To fully represent the real world with point samples, in practice, a large number of points is required. Therefore, the processing of such large-scale point clouds is computationally expensive, especially for consumer devices that have limited computational power, e.g., smartphones, tablets, and automotive navigation systems.

To process the input point cloud at an affordable computational cost, one solution is to down-sample it first, where the down-sampled point cloud summarizes the geometry of the input point cloud while having significantly fewer points. The down-sampled point cloud is then fed to the subsequent machine task for further consumption. However, point cloud data can be exploited for various tasks, such as scene flow estimation, classification, detection, segmentation, and compression, etc. Different tasks focus on different aspects of a point cloud. For instance, classification relies on the saliency points of the geometry, while object segmentation needs to distinguish the points on one object from the others, and scene flow estimation counts the dynamics of a point cloud. Hence, an adaptive point cloud down-sampling algorithm that is task-aware is helpful. Therefore, when faced with different tasks, the same point cloud can be down-sampled to different ones to facilitate the subsequent tasks.

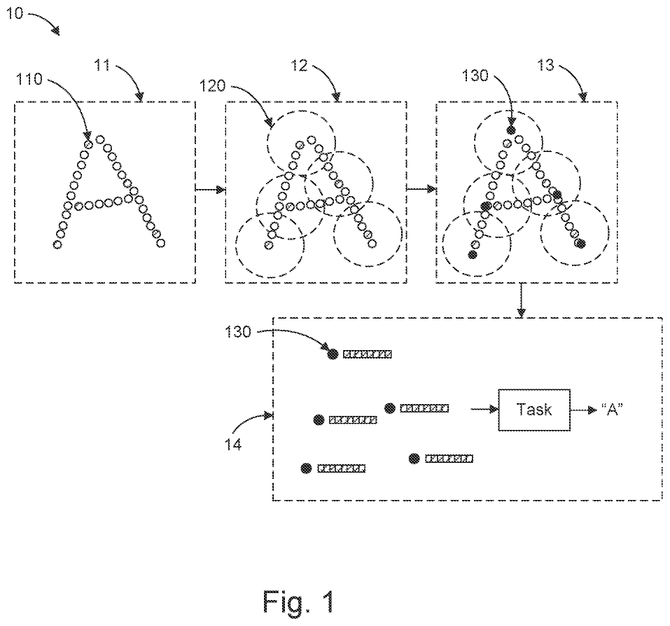

FIG. 1 illustrates a method 10 of down-sampling an input point cloud X with n points for subsequent machine tasks according to the present principles. At step 11, an initial down-sampled point cloud with m points (m<n) is selected. A set of m points, like point 110, of the input point cloud is selected using any applicable method. At step 12, for a point 110 in the initial down-sampled point cloud (herein called the “anchor point”), its nearby points are aggregated from the point cloud X, leading to a local point set 120. In this way, each anchor point in the initial down-sampled point cloud is associated with a local point set from the point cloud X. At step 13, each point set is fed to a module herein called the Set Distillation (SD) function, resulting in a representative point 130 and its corresponding set-level feature.

According to the present principles, given a point set (and other auxiliary information if available), the SD function first computes a point-level feature vector for each point in the point set, and a set-level feature vector describing the overall point set. This step is accomplished, for example, using a neural network module (herein called P-Net) structured according to the present principles. By taking as inputs the point-level feature vectors of each point and the set-level feature vector, a representative position is computed. This step is achieved through either a deterministic approach or another neural network module. After that, the SD function outputs the representative position, as well as the set-level feature to represent the geometry of the point set. By using the SD function, the obtained representative position is not limited to the points within the point set.

At step 14, the m representative points are aggregated as the updated down-sampled point cloud, which is fed to the subsequent task for further processing. The m set-level features are also optionally output and fed to the subsequent task.

Down-sampling method 10 is integrated with the subsequent task and trained in an end-to-end manner, allowing down-sampling method 10 be task-aware, i.e., adaptive to the machine task. On the other hand, through end-to-end training, the down-sampled point clouds obtained by method 10 are able to capture the underlying geometry for a particular machine task, regardless of the how original input point cloud is sampled from the scene. Specifically, given two different point clouds which sample the same surface, i.e., one point cloud is the resampled version of the other, for the same subsequent machine task, method 10 results in two down-sampled point clouds that are closely resemble each other.

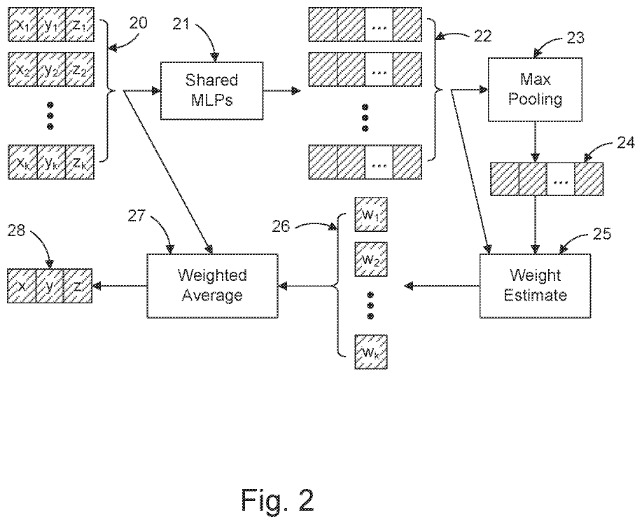

FIG. 2 diagrammatically illustrates an example of the SD function. Given a point set 20, the SD function feeds the point set to a PointNet architecture as described, for example, in “PointNet: Deep learning on point sets for 3D classification and segmentation,” in proc. IEEE Conference on Computer Vision and Pattern Recognition, pp. 652-660, 2017, by C. R. Qi, H. Su, K. Mo, L. J. Guibas. A module 21 of PointNet computes point-level feature vectors 22 for each point with shared multi-layer perception (MLP). These point-level feature vectors 22 are then aggregated with a max-pooling operation 23, resulting in a set-level feature vector 24 describing the whole point set.

According to the present principles, a set of weights 26 is computed for the points in the whole point set. To do so, an affinity value (e.g., weight estimate) between each point-level feature vector 22 and the set-level feature vector 24, is provided by a module 25 that computes the inner-product between them. This affinity value describes the of the degree to which its associated point is representative of the whole point set. A module 27 performs a weighted average 28 of the points with the computed weights 26, to generate a representative position for the point set. The affinity values are converted to a set of weights using the Softmax(·) function, so that all the weight values are greater than 0 and summed up to 1. A weighted averaging of the x coordinates of all points in the point set with the obtained weights is performed, leading to the x coordinate of the generated representative point. Similarly, the y and z coordinates of the representative point are computed with the weights. The generated x, y and z coordinates form the position of the representative point. The SD function outputs the representative point, as well as the set-level feature generated by PointNet.

In a first embodiment of the present principles, the down-sampling of a given point cloud X containing n points is performed using the presented SD function. At a first step, an initial down-sampled point cloud with m points is generated using the Farthest point sampling (FPS) method, where the obtained points are called the “anchor points”. Farthest point sampling is a known point cloud down-sampling approach and is described for instance in “The Farthest point strategy for progressive image sampling,” IEEE Trans. on Image Processing, vol. 6, no. 9, pp. 1306-1315, 1997. FPS is based on repeatedly choosing the next sample point in the least-explored area. Given a point cloud X and its sampled subset, the FPS algorithm chooses the farthest point to the subset from the rest of the points in X with some distance measure. This farthest point is then added to the subset. Here the subset is initialized by randomly picking a point from X. The FPS algorithm repeats this point selection process until a certain condition is met, e.g., the number of points in the subset reaches a predefined threshold. This classic sampling approach is deterministic and does not consider the downstream task.

At a second step of the first embodiment, for each anchor point, its nearby points are collected through a ball query procedure, i.e., all points in X lying within a predefined distance r to the anchor point are identified and collected, forming a local point set for that anchor point. At a third step, every local point set (m in total) is fed to the SD function individually, leading to the updated down-sampled point cloud (with m points), accompanied with m set-level features. At a fourth step, the m down-sampled points (and optionally, the set level features) are fed to the subsequent task. This down-sampling method is trained end-to-end with the subsequent machine task, to make the neural network layers in the SD function task-aware, i.e., be adaptive to the subsequent task.

In a second embodiment, the computation of the point-wise weights of the SD function differs. Specifically, in the SD function of this embodiment a distance is computed for each point in the point set, which is the Euclidean distance between its point-level feature vector, and the set-level feature vector. Herein, this distance value is denoted by dᵢ for a point i. dᵢ value is plugged into a Gaussian kernel to compute a weight, i.e., wᵢ=exp(−dᵢ²/σ²) with a constant σ. The weight values of the point set are further normalized so that they summed up to one. Then, a weighted averaging of the points in the point set is performed using the obtained weights, as presented in relation to the first embodiment, leading to the representative point position. The SD function returns the representative point as well as the set-level feature obtained by the PointNet.

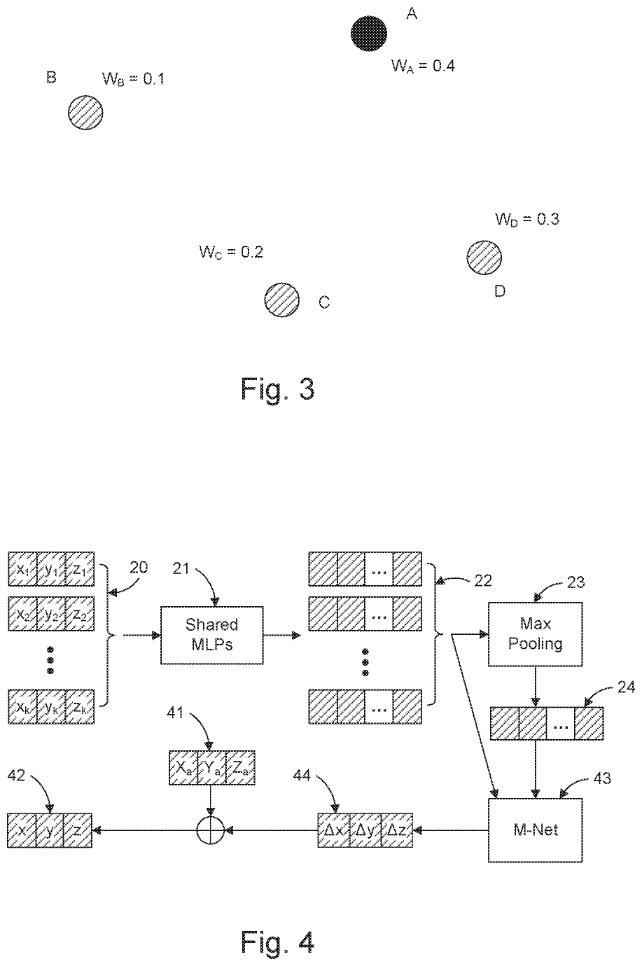

In a third embodiment, each down-sampled point is obtained by selecting a critical point in a local point set. A difference between this embodiment and the first embodiment lies in the SD function, where the SD function here chooses a representative point from the input point set. Similar to the first embodiment, given a point set, the SD function computes a set of weights for each point in the whole set. Then the SD function directly returns the point with the maximum weight as the representative point, as well as returns the set-level feature generated by PointNet. FIG. 3 illustrates an example, where a point A is chosen as the representative point because it has the largest weight. In a variant of the third embodiment, the method in the second embodiment to compute the weights for the points in the point set, where the weights are obtained through a Gaussian kernel, may also be used.

In a fourth embodiment, the SD function takes as inputs not only a local point set from the point cloud X but also a one-hot vector indicating which point is the anchor point of the point set. Consequently, the SD function in this embodiment can utilize the knowledge of the anchor point position to generate the representative point. Specifically, in the SD function, before the computation of the PointNet, the position vector of each point in the point set is augmented, by appending the position vector of the anchor point (and the feature vector of the anchor, which is another input to the SD function, if available). With the information of the anchor position appended, the augmented point set is then processed by the PointNet, leading to the point-level feature vectors of each point and the set-level feature vector.

FIG. 4 illustrates a fifth embodiment of down-sampling an input point cloud according to the present principles. Instead of generating the representative point by a weighted average, this embodiment directly modifies the position of the anchor point 41, then returns the modified position 42 as the representative point. Specifically, similar to the fourth embodiment, the SD function in this embodiment also takes as inputs a local point set 20 as well as a one-hot vector indicating which point is the anchor point 41 of the point set. Once the point-level feature vectors 22 and the set-level feature 24 are obtained, they are fed to another neural network 43, herein called the “M-Net.” The M-Net specifically outputs a modification vector 44 relative to the anchor point position; it may be implemented with a PointNet architecture. The representative point position 42 is obtained by adding the modification vector 44 and the anchor position 41. In the end, the SD function still returns the representative point and the set-level feature vector. The fifth embodiment can be combined with the fourth embodiment where the points fed to the SD function are first augmented by the information of the anchor position.

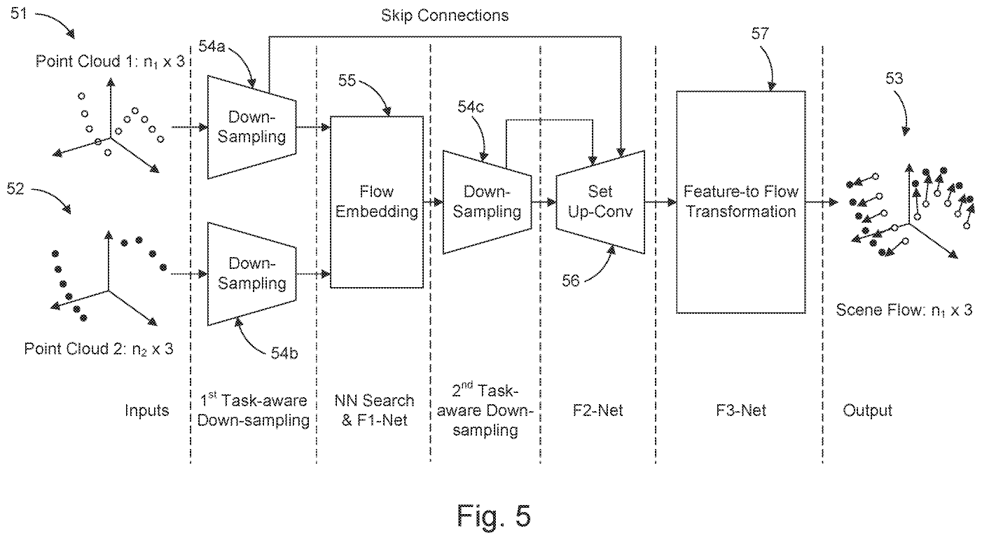

FIG. 5 diagrammatically illustrates how to integrate the task-aware point cloud down-sampling method of the present principles with a sub-sequent machine task. As an example, the task of scene flow estimation for the 3D point cloud is considered, without loss of generality, for illustrating this sixth embodiment. This task takes as inputs two consecutive 3D point cloud frames in a point cloud sequence, e.g., first point cloud frame 51 and second point cloud frame 52, and aims to estimate the scene flow from the first point cloud frame to the second point cloud frame, that is the movement of each 3D point from the first point cloud frame to the second point cloud frame. The difficulty is that points' indices are lost from one frame to consecutive frames. In this scenario, output scene flow 53 includes a set of 3D vectors, where each 3D vector is associated with a point of the first point cloud frame. The 3D vectors describe how the points from the first point cloud frame physically move to the surface of the second point cloud frame. In other words, the scene flow between two-point cloud frames describes the dynamics of the point clouds, which is essential for many practical applications, e.g., autonomous driving, AR/VR, and robotics.

In this sixth embodiment, the down-sampling methods presented in the previous embodiments are applied multiple times. The overall neural network architecture of this embodiment takes an hour-glass structure with skip connections. The method of the present sixth embodiment comprises a first stage generating a first and a second down-sampled point clouds, from the first and the second point cloud frames, respectively. This is achieved using two task-aware down-sampling modules 54a and 54b (based on any one of the previous embodiments) for both inputs. Two consecutive point clouds of a point cloud sequence may be considered as one point cloud in which points carry a temporal information indicating whether they belong to the first or to the second point cloud. Indeed, two point clouds of a sequence of point clouds share the same frame of reference and their points can be merged in one point cloud. At a second stage, a point set for each point in the first down-sampled point cloud is aggregated by searching for its nearest-neighboring points from the second down-sampled point cloud. The method computes a first inter-frame feature fusing the information from both point cloud frames, for each point in the first down-sampled point cloud, using the information of the point (its position and the point-level feature) as well as its associated nearest-neighboring point set. This second stage is accomplished using a neural network module 55, herein called “F1-Net”. At a third stage, the first down-sampled point cloud is further down-sampled with a task-aware down-sampling module 54c according to the present principles, taking the points and the associated inter-frame features as inputs. At a fourth stage, a second inter-frame feature is computed for each point in the first point cloud frame, using an up-sampled neural network module 56, herein called “F2-Net”. This F2-Net module corresponds to stacks of Set Up-Cony layers, for example as presented in “FlowNet3D: Learning scene flow in 3D point clouds,” in proc. IEEE Conference on Computer Vision and Pattern Recognition, pp. 529-537, 2020. Such a neural network module interpolates the point-wise features hierarchically. At a fifth stage, a scene flow vector is computed for each point in the first point cloud frame, using a feature-to-flow transformation neural network module 57, herein called “F3-Net”. F3-Net is implemented with pointwise MLP layers. According to the present principles, skip-connections between the task-aware down-sampling module and the F2-Net are added to merge information from the early layers.

The entire neural network architecture of FIG. 5, including the task-aware down-sampling modules 54a-c, and other neural network modules, is trained end-to-end using an end-point-error (EPE) loss function as described in “FlowNet3D”. After the training process, the proposed task-aware down-sampling modules become well integrated with the other neural network modules, which facilitates the estimation of accurate scene flow vectors.

In FIG. 5, integrating the task-aware point cloud down-sampling method is described in relation to a scene flow estimation task. The same principles may apply without loss of generality to any other task dealing with point clouds as described above.

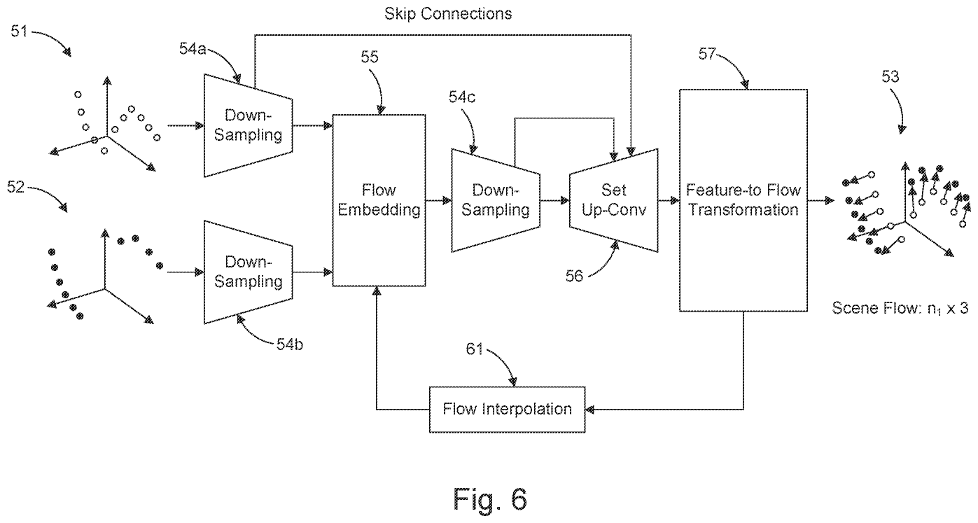

FIG. 6 illustrates a seventh embodiment of an integrated task-aware point cloud down-sampling method. This seventh embodiment estimates a scene flow 53 based on two input point cloud frames 51 and 52. The method iteratively updates the estimated scene flow to refine its accuracy through a flow interpolation module 61. An initial point-wise scene flow for the first point cloud frame 51 is estimated using the method described above with respect to FIG. 5. Based on this initial scene flow, a point-wise scene flow is generated for the first down-sampled point cloud. This is to achieve based on a scene flow interpolation neural network module 61, herein called “I-Net”. I-Net is implemented in the same manner as a Set Up-Cony layer as described in “FlowNet3D”. A shifted down-sampled point cloud is generated, via shifting each point in the first down-sampled point cloud by its associated scene flow vector. A point set is then aggregated for each point in the shifted down-sampled point cloud, by searching for its nearest-neighboring points from the second down-sampled point cloud. In this way, each point in the first down-sampled point cloud is associated with its shifted version, as well as an updated nearest-neighboring point set using the shifted version as the query point. These updated nearest-neighboring point sets are more accurate/informative for scene flow estimation.

With the first down-sampled point cloud and all the updated nearest-neighboring point sets, a second point-wise scene flow for the first point cloud frame, by executing F1-Net 55, the second task-aware down-sampling module 54c, F2-Net 56, and F3-Net 57 again. An alternative of this stage is that, based on the shifted down-sampled point cloud, and the updated nearest-neighboring point sets, executing F1-Net, the second task-aware down-sampling module, F2-Net, and F3-Net again, leading to a residual point-wise scene flow. By adding the residual point-wise scene flow to the initial point-wise scene flow, a second point-wise scene flow for the first point cloud frame can be obtained. In the end, the second point-wise scene flow is output as the result. This recurrent scene flow estimation scheme can be executed iteratively for more than two iterations until a certain condition is satisfied, e.g., the number of iterations reaches a predefined threshold.

For this seventh embodiment, integrate the task-aware point cloud down-sampling method is described in relation to a scene flow estimation. The same iterative principles may apply without loss of generality to any other task dealing with point clouds as described above.

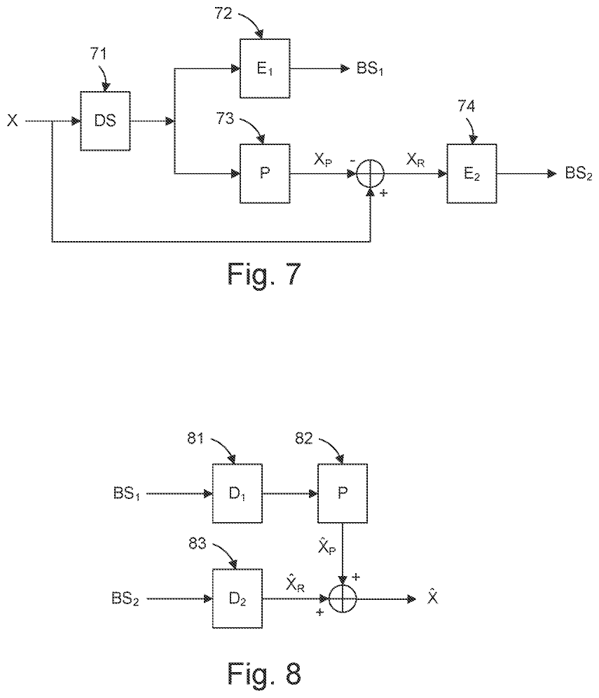

FIG. 7 illustrates a method of point cloud compression using an embodiment of a task-aware point cloud down-sampling method according to the present principles. In this encoder embodiment, the down-sampled point cloud is used to construct a predicted point cloud for a predictive coding task. Given an input point cloud X to be encoded, a down-sampled point cloud is generated using a task-aware point cloud down-sampling method 71 as described in relation to one of the previous embodiments. The down-sampled point cloud, and optionally, the generated set-level feature vectors, are on one hand, encoded by a first entropy encoder 72 leading to a first bit-stream BS₁; while on the other hand, the down-sampled point cloud, and optionally, the generated set-level feature vectors are fed to a predictor construction module 73 which endeavors to generate a predicted point cloud X_{P} that is close to X. In the end, a second entropy encoder 74 encodes the residual point cloud X_{R}=X−X_{P}, leading to a second bit-stream BS₂. The two bit-streams together are sent to the decoder. The entropy encoders 72 and 74 can either be lossless or lossy.

FIG. 8 illustrates a decoder embodiment of the present principles. The down-sampled point cloud (and the feature vectors if available) is decoded from the first bit-stream BS1 by a decoder module 81 and fed to a predictor construction module 82 to obtain the predicted point cloud \hat{X}_{P}. In parallel or sequentially, the residual point cloud \hat{X}_{R} from the second bit-stream BS2 is decoded by a decoder module 83. By adding up \hat{X}_{P} and \hat{X}_{R}, the reconstructed point cloud \hat{X} is obtained.

This decoder embodiment can be used for either inter-frame predictive coding or intra-frame predictive coding. It differs from conventional scalable coding in two aspects. On one hand, the decoder does not limit the down-sampled point cloud to be a subset of the input point cloud, On the other hand, aside from the down-sampled point cloud, the feature vectors produced the task-aware down-sampling module of the encoder in relation to FIG. 7 can also be employed to generate the predicted point cloud, which gives the present predictive coding scheme more flexibility.

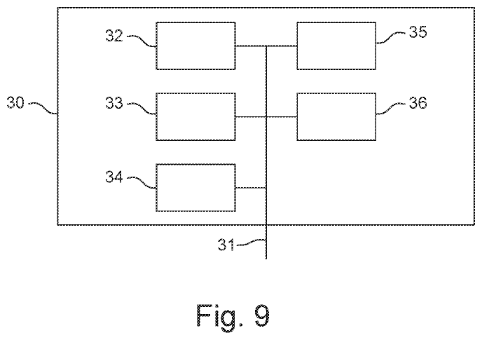

FIG. 9 shows an example architecture of a device 30 which may be configured to implement a method described in relation FIGS. 1, 5, 6, 7, and 8. The different embodiments of encoders and decoders according to the present principles may implement this architecture. Alternatively, each module of encoders and/or decoders according to the present principles may be a device according to the architecture of FIG. 9, linked together, for instance, via their bus 31 and/or via I/O interface 36.

Device 30 comprises the following elements that are linked together by a data and address bus 31:
a microprocessor 32 (or CPU), which is, for example, a DSP (or Digital Signal Processor);
a ROM (or Read Only Memory) 33;
a RAM (or Random Access Memory) 34;
a storage interface 35;
an I/O interface 36 for reception of data to transmit, from an application; and
a power supply, e.g., a battery (not shown).

In accordance with an example, the power supply is external to the device. In each of the mentioned memory, the word «register» used in the specification may correspond to an area of small capacity (some bits) or to very large area (e.g. a whole program or large amount of received or decoded data). The ROM 33 comprises at least a program and parameters. The ROM 33 may store algorithms and instructions to perform techniques in accordance with present principles. When switched on, the CPU 32 uploads the program in the RAM and executes the corresponding instructions.

The RAM 34 comprises, in a register, the program executed by the CPU 32 and uploaded after switch-on of the device 30, input data in a register, intermediate data in different states of the method in a register, and other variables used for the execution of the method in a register.

The implementations described herein may be implemented in, for example, a method or a process, an apparatus, a computer program product, a data stream, or a signal. Even if only discussed in the context of a single form of implementation (for example, discussed only as a method or a device), the implementation of features discussed may also be implemented in other forms (for example a program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

In accordance with examples of the present disclosure, the device 30 belongs to a set comprising:
a mobile device;
a communication device;
a game device;
a tablet (or tablet computer);
a laptop;
a still picture or a video camera, for instance equipped with a depth sensor;
a rig of still picture or video cameras;
an encoding chip;
a server (e.g., a broadcast server, a video-on-demand server or a web server).

Implementations of the various processes and features described herein may be embodied in a variety of different equipment or applications, particularly, for example, equipment or applications associated with data encoding, data decoding, view generation, texture processing, and other processing of images and related texture information and/or depth information. Examples of such equipment include an encoder, a decoder, a post-processor processing output from a decoder, a pre-processor providing input to an encoder, a video coder, a video decoder, a video codec, a web server, a set-top box, a laptop, a personal computer, a cell phone, a PDA, and other communication devices. As should be clear, the equipment may be mobile and even installed in a mobile vehicle.

Additionally, the methods may be implemented by instructions being performed by a processor, and such instructions (and/or data values produced by an implementation) may be stored on a processor-readable medium such as, for example, an integrated circuit, a software carrier or other storage device such as, for example, a hard disk, a compact diskette (“CD”), an optical disc (such as, for example, a DVD, often referred to as a digital versatile disc or a digital video disc), a random access memory (“RAM”), or a read-only memory (“ROM”). The instructions may form an application program tangibly embodied on a processor-readable medium. Instructions may be, for example, in hardware, firmware, software, or a combination. Instructions may be found in, for example, an operating system, a separate application, or a combination of the two. A processor may be characterized, therefore, as, for example, both a device configured to carry out a process and a device that includes a processor-readable medium (such as a storage device) having instructions for carrying out a process. Further, a processor-readable medium may store, in addition to or in lieu of instructions, data values produced by an implementation.

As will be evident to one of skill in the art, implementations may produce a variety of signals formatted to carry information that may be, for example, stored or transmitted. The information may include, for example, instructions for performing a method, or data produced by one of the described implementations. For example, a signal may be formatted to carry as data the rules for writing or reading the syntax of a described embodiment, or to carry as data the actual syntax-values written by a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations are contemplated by this application.

1. A method comprising, for a point cloud:
generating, for each point of the point cloud, a point-level feature vector by inputting a position vector of the point in a neural network, and generating a set-level feature vector for the point cloud by using the neural network;
generating a representative position based on the point-level feature vectors and on the set-level feature vector; and
outputting the representative position and the set-level feature vector as the set descriptor.

2. The method of claim 1, wherein generating the representative position comprises:
computing a weighting factor for each point in the point cloud based on a similarity measure by computing an inner-product between the point-level feature vector and the set-level feature vector; and
generating the representative position by a weighted average of all points using their weighting factor.

3. The method of claim 1, wherein generating the point-level and the set-level feature vectors comprises:
accessing an anchor point of the point cloud by performing a farthest point sampling;
generating, for each point of the point cloud, an augmented point by appending a position vector of the anchor point to the position vector of the point; and
using the augmented points as an input of the neural network.

4. (canceled)

5. The method of claim 1, wherein generating the representative position comprises:
accessing an anchor position of the point cloud by performing a farthest point sampling;
generating a modification vector relative to the anchor position by an augmented neural network; and
generating the representative position by adding the modification vector to the anchor position.

6. The method according to claim 1, wherein the point cloud is, first, down-sampled by a task-aware down-sampling method.

7. The method of claim 6, wherein the task-aware method is a predictive coding task and wherein the down-sampled point cloud is:
encoded by a first entropy encoding method, and
fed to a predictor construction module to obtain a predicted point cloud, and the method comprising encoding a residual point cloud being a difference between the point cloud and the predicted point cloud by a second entropy encoding method.

8. The method of claim 7, wherein the set-level feature vector is encoded with the down-sampled point cloud by the first entropy encoding method.

9. A method for retrieving a point cloud from a data stream, the method comprising:
obtaining, from the data stream, a down-sampled point cloud, a residual point cloud and a set-level feature vector;
feeding the down-sampled point cloud and the set-level feature vector to a predictor construction module to obtain a predicted point cloud; and
retrieving the point cloud by adding up the predicted point cloud to the residual point cloud.

10. (canceled)

11. A device comprising a processor associated with a memory, the processor being configured to, for a point cloud:
generate, for each point of the point cloud, a point-level feature vector by inputting a position vector of the point in a neural network, and generate a set-level feature vector for the point cloud by using the neural network;
generate a representative position based on the point-level feature vectors and on the set-level feature vector; and
output the representative position and the set-level feature vector as the set descriptor.

12. The device of claim 11, wherein the processor is configured to generate the representative position by:
computing a weighting factor for each point in the point cloud based on a similarity measure by computing an inner-product between the point-level feature vector and the set-level feature vector; and
generating the representative position by a weighted average of all points using their weighting factor.

13. The device of claim 11, wherein the processor is configured to generate the point-level and the set-level feature vectors by:
accessing an anchor point of the point cloud by performing a farthest point sampling;
generating, for each point of the point cloud, an augmented point by appending a position vector of the anchor point to the position vector of the point; and
using the augmented points as an input of the neural network.

14. (canceled)

15. The device of claim 11, wherein the processor is configured to generate the representative position by:
accessing an anchor position of the point cloud by performing a farthest point sampling;
generating a modification vector relative to the anchor position by an augmented neural network; and
generating the representative position by adding the modification vector to the anchor position.

16. The device according to claim 11, wherein the processor first down-sample the point cloud by using a task-aware down-sampling method.

17. The device of claim 16, wherein the task-aware method is a predictive coding task and wherein the down-sampled point cloud is:
encoded by a first entropy encoding method, and
fed to a predictor construction module to obtain a predicted point cloud, and the method comprising encoding a residual point cloud being a difference between the point cloud and the predicted point cloud by a second entropy encoding method.

18. The device of claim 17, wherein the set-level feature vector is encoded with the down-sampled point cloud by the first entropy encoding method.

19. A device for retrieving a point cloud from a data stream, the device comprising a processor associated with a memory, the processor being configured to:
obtain, from the data stream, a down-sampled point cloud, a residual point cloud and a set-level feature vector;
feed the down-sampled point cloud and the set-level feature vector to a predictor construction module to obtain a predicted point cloud; and
retrieve the point cloud by adding up the predicted point cloud to the residual point cloud.

20. (canceled)
